(19) United States
(12) Patent Application Publication
(10) Pub. No.: US 2026/0218810 A1
(43) Pub. Date: Jul. 30, 2026

(54) VALVE HEALTH MONITORING AND EVENT DETECTION

(71) Applicant: Schlumberger Technology Corporation, Sugar Land, TX (US)

(72) Inventors: Christopher Bridge, Bristol (GB); Aulia Ahmad Naufal, Kuala Lumpur (MY); Justo Elias Matheus Valero, Lysaker (NO); Bradley Martin, Kuala Lumpur (MY); Ishan Appu, Gurgaon (IN); Tania Constance Mabounou, Pointe Noire (CG)

(21) Appl. No.: 19/460,436

(22) Filed: Jan. 27, 2026

Related U.S. Application Data
(60) Provisional application No. 63/750,795, filed on Jan. 29, 2025.

(51) Int. Cl. F16K 37/00; F16K 3/02

(52) U.S. Cl. CPC F16K 37/0083; F16K 3/02

(57) ABSTRACT

A method for monitoring valve health. The method may include receiving valve data from a source, pre-processing the received valve data, and detecting at least one event based on the pre-processed valve data to provide event signature data. The method may also include determining that the detected event is an anomaly based on the event signature data, classifying the anomaly based on the event signature data, and performing an action based on the classified anomaly. The method may also include training an event classification model to classify the anomaly according to the event signature data. Training the event classification model to classify the anomaly may include reviewing and labeling a plurality of plots of the event signature data by a subject matter expert and then providing the labeled event signature data to the event classification model, and validating the classification model by the subject matter expert.

### CROSS-REFERENCE TO RELATED APPLICATIONS

This application claims priority to U.S. Provisional Patent Application No. 63/750,795, filed on Jan. 29, 2025, which is incorporated by reference.

### BACKGROUND

Valves play a role in many industries. Most valves do not have sensors to measure the position of the valve (open, closed or position in transit) or other diagnostic sensors to measure the health of the valve. During long periods when the valves are not operated, for example when they are open or closed, there is generally no indication of the valve health. Once operated (open to closed or closed to open) sensors on the hydraulic actuator and hydraulic line give some insight into the condition/status of the valve and if it is functioning correctly. In some cases, when there are issues with the actuator itself (e.g. leaks, stuck piston, excess friction) they may be seen directly. In the case the gate, seat, stem or other process wetted part of the valve may be causing an issue, the issues may often be inferred from the actuator data.

Many systems include the measurement of hydraulic supply line and return line pressure as well as the actuator, or function hydraulic pressure. See, for example, the hydraulic circuit illustrated in FIG. 2A. In some cases, hydraulic fluid flow rate for the supply and return lines and/or the change in volume of hydraulic fluid accumulators are measured. A plot of the function, supply, and return pressures over time is referred to as the valve actuation “signature.” An example of a valve actuation signature may be seen in FIG. 2B.

An experienced operator or subject matter expert (SME) may generally identify if there is an issue when the signature deviates from “normal.” However, in most cases, operators are not experts in valves. They may not be aware or have access to information about the valve type/configuration, size or other parameters that determine what is normal versus what may be anomalous.

Even if a problem is identified, the exact cause may be more difficult to determine, for example a valve stuck in the open, closed or partially open position. For many operators, issues are subtle and hard to identify, for example when the valve takes longer to open or close than normal. In many cases, it may be difficult to identify an anomaly at all.

In addition, identification of a singular anomalous valve event does not give insight into long term trends such as reoccurring events, valve degradation over time, or the current valve health status. Therefore, operators may continue to operate the valve without knowing if the valve will perform optimally on the next operation. Maintenance is typically performed on a fixed schedule, for example every 5 years regardless of valve status. In many cases a valve will be operated at full specification until it fails. This may result in a leak to the environment, the shut down of production, and/or require emergency intervention to repair or replace the valve. In this scenario, the cost of lost production and maintenance may be extremely high. One strategy to avoid such a scenario may include knowing when a valve is likely to fail and then operating the valve lower than its maximum specification or less frequently. The valve may then continue to operate for longer and survive until the next planned maintenance, significantly reducing the cost impact.

What is needed is a system for live data processing, anomaly detection, and health analysis of hydraulically activated valves that is designed to predict and prevent failures in oil and gas operations. The valves may be subsea valves, subsurface valves, or surface valves. The valves may be gate valves, ball valves, plug valves, or other hydraulically operated valves. The approach should combine sophisticated valve event detection with anomaly detection and a user-friendly dashboard to deliver actionable insights for predictive maintenance to help support the reliability and safety of assets.

### SUMMARY

In certain embodiments, a method is provided for monitoring valve health. The method may include receiving valve data from a source, pre-processing the received valve data, detecting at least one event based on the pre-processed valve data to provide event signature data, determining that the detected event is an anomaly based on the event signature data, classifying the anomaly based on the event signature data, and performing an action based on the classified anomaly.

In certain embodiments, a computing system is provided. The computing system may include one or more processors and a memory system including one or more non-transitory computer-readable media storing instructions that, when executed by at least one of the one or more processors, cause the computing system to perform operations. The operations may include receiving valve data from a source, pre-processing the received valve data, detecting at least one event based on the pre-processed valve data to provide event signature data, determining that the detected event is an anomaly based on the event signature data, classifying the anomaly based on the event signature data, and performing an action based on the classified anomaly.

In certain embodiments, a non-transitory computer-readable medium is provided storing instructions that, when executed by one or more processors of a computing system, cause the computing system to perform operations. The operations may include receiving valve data from a source, pre-processing the received valve data, detecting at least one event based on the pre-processed valve data to provide event signature data, determining that the detected event is an anomaly based on the event signature data, classifying the anomaly based on the event signature data, and performing an action based on the classified anomaly.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2A illustrates a schematic diagram of a hydraulic circuit, according to an embodiment.

FIG. 2B illustrates a plot of pressure over time representing a valve actuator signature, according to an embodiment.

FIG. 3 illustrates a series of perspective cross sectional views of a hydraulic gate valve when closed, opening, and fully opened, according to an embodiment.

FIG. 4A illustrates a cross-sectional view of a hydraulic fail closed valve, according to an embodiment.

FIG. 4B illustrates a cross-sectional view of a hydraulic fail as-is valve, according to an embodiment.

FIG. 5 illustrates a flowchart for a method to determine the health of a valve using real time data ingestion, according to an embodiment.

FIG. 6 illustrates a flowchart for a method to determine the health of a valve using historical data ingestion, according to an embodiment.

FIG. 7 illustrates a flowchart for a method to determine the health of a valve using a singular or one-off data ingestion, according to an embodiment.

FIG. 8 illustrates a flowchart for a method to classify anomalous events using limited data and where anomalies are unknown, according to an embodiment.

FIG. 9 illustrates a flowchart for a method to classify anomalous events using large amounts of data and where anomalies are well known, according to an embodiment.

FIG. 10 illustrates a flowchart for a method to classify anomalous events using a moderate amount of data and where anomalies are both known and unknown, according to an embodiment.

FIG. 11 illustrates a flowchart for a method to train an event classification model, according to an embodiment.

FIG. 12A illustrates a plot of count over duration representing a distribution of durations by diameter in hydraulically supported valve actuations, according to an embodiment.

FIG. 12B illustrates a plot of count over duration representing a distribution of durations by fail-safe type in hydraulically supported valve actuations, according to an embodiment.

FIG. 13 illustrates a flowchart for a method to calculate a vale survival value, according to an embodiment.

FIG. 14 illustrates an exemplary screenshot of a dashboard displaying operator insights related to the performance of a valve, according to an embodiment.

FIG. 15 illustrates a flowchart of the method described herein, according to an embodiment.

FIG. 16 illustrates a schematic view of a computing system for performing at least a portion of the method described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted as referring to a subset.

### System Overview

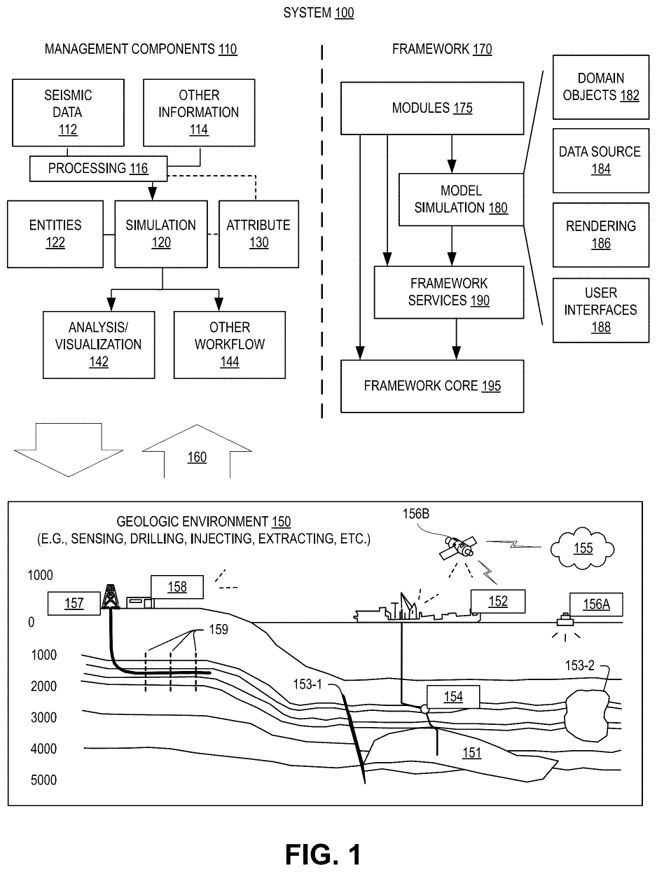

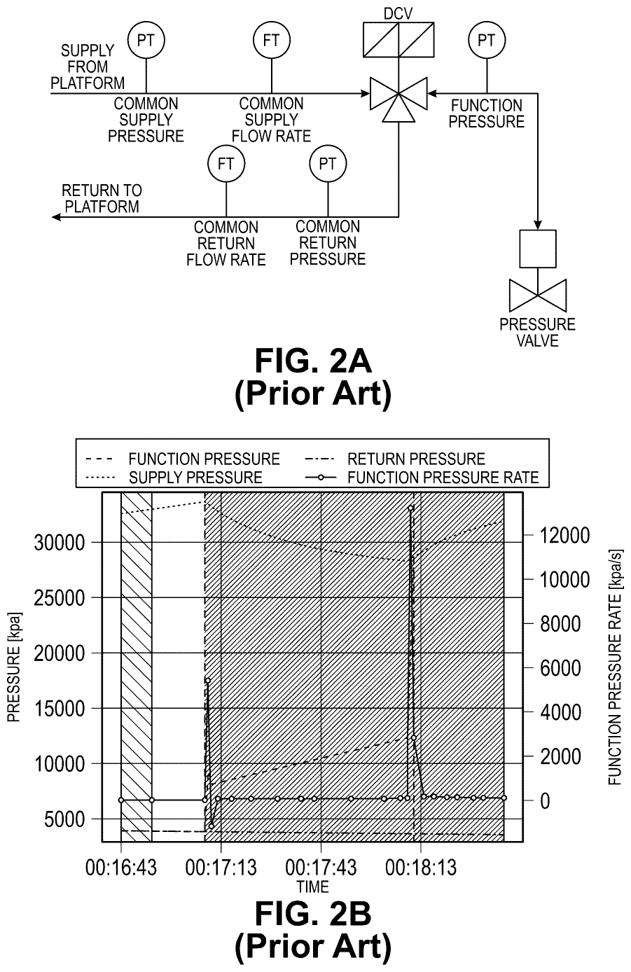

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122.

Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® NET® framework (Redmond, Washington), which provides a set of extensible object classes. In the .NET® framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY™ software (SLB, Houston, Texas). More particularly, SYMMETRY™ may process workflows in a single integrated environment with accurate thermodynamic fluid representation and consistent modeling across multiple disciplines including process, production, and HSE. The simulator integrates steady-state and transient (e.g., dynamic) analyses that may be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM™ (SLB, Houston, Texas). More particularly, PIPESIM™ is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and displays information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

A network architecture for drilling operations typically involves a multi-layered setup designed to handle the complexities of rig environments, as shown in FIG. 1. The infrastructure may be segmented into distinct network zones, such as an information technology (IT) network, an operational technology (OT) network, and a rig network, to ensure security and manageability.

The IT network may include centralized support and monitoring systems, such as the Service Provider Central Support Network, which interacts with the rig networks via secure communication channels. The OT network may operate within a more restrictive environment, managing essential control systems and acquisition networks, including surface and downhole data acquisition devices. Each network segment is further isolated using firewalls and hypervisor technologies, enabling network segmentation and perimeter security.

The rig network connects critical edge devices, such as drilling control units, acquisition systems, and other wellsite equipment which perform various automation and data processing tasks. These edge devices often operate with limited bandwidth, making it challenging to transmit large amounts of data in real time. Therefore, a robust strategy for monitoring and data collection is preferred to ensure efficient operation without overwhelming the network.

### Valve Health Monitoring and Event Detection

According to certain embodiments, to evaluate if a remotely operated gate valve with a hydraulic actuator (sometimes referred to as “valve” or “valves”) is functioning correctly, an operator may observe data received from the valve, as it is functioning, either in real time or by reviewing historical data. In certain embodiments, the approach disclosed herein may help address the issues with existing manual valve monitoring process such as identifying when a valve actuation event occurs and if it is opened or closed, determining the type/configuration of a valve (Fail Open/Close/As Is) and its size and other parameters, and establish a baseline signature for normal valve actuation events and the identification of an anomalous valve actuation event. The current approach may also assist determining the failure mechanism(s) or root cause(s) of an anomalous event, determining if there is a trend in anomalous events or failure mechanisms, and determining the valve's current health status, the remaining useful life, when maintenance will be required, what maintenance should be performed, and if/when it is likely to fail. Additionally, the current approach may be used to compare the performance of different valves, manage valves by risk, and propose alternative operating modes to extend life and/or delay failure.

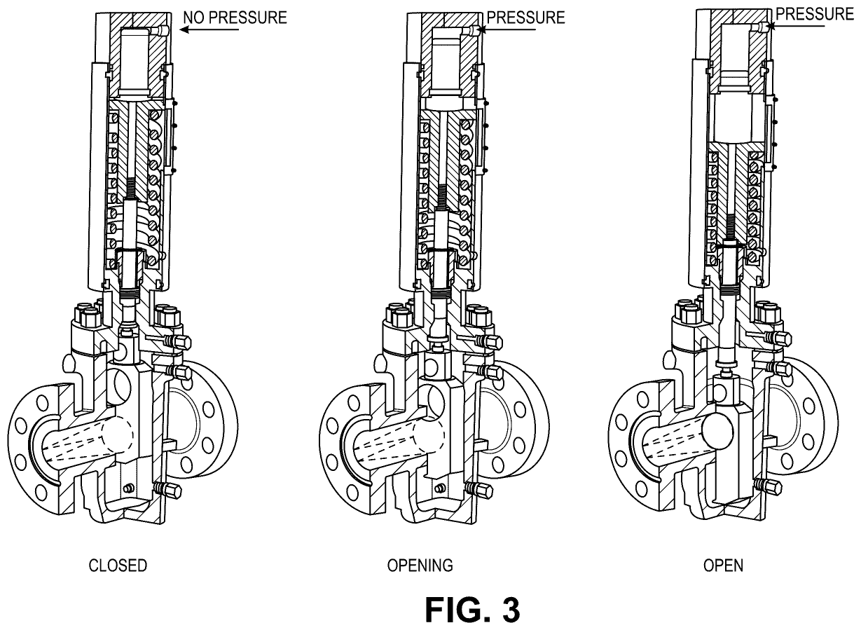

The primary function of a valve is to isolate/block/shut off flow and to allow flow. FIG. 3 illustrates a gate valve during an opening sequence, namely when the valve is closed, partially open, and fully open. Valves are generally full bore, meaning that when open, the diameter of the valve opening/orifice is the same diameter as in inlet and outlet pipe diameter so that there is no restriction to the flow. Valves are not typically designed to be operated in a partially open state.

In a typical production application, valves remain in a fully open or fully closed position most of the time. They are operated infrequently, usually to isolate/shutoff flow, bypass one part of a pipe network, bypass certain equipment or establish flow throughout the same. Typically, an operator selects to operate one or more valves through a digital interface of an automated control system, some examples being a Human Machine Interface (HMI) or other software. The control system controls the Hydraulic Pumping Unit (HPU) or equivalent, opening and closing hydraulic fluid control valves to direct hydraulic fluid to the valve's actuator or allow hydraulic fluid to drain from the actuator. Other methods to open valves include operating multiple valves with an automated sequence, operating valves automatically in response to an event/sensor reading, or by operating the valves directly from the HPU control panel. In all these examples, if there are pressure sensors on the hydraulic lines, the actuation event may be monitored as is further described below.

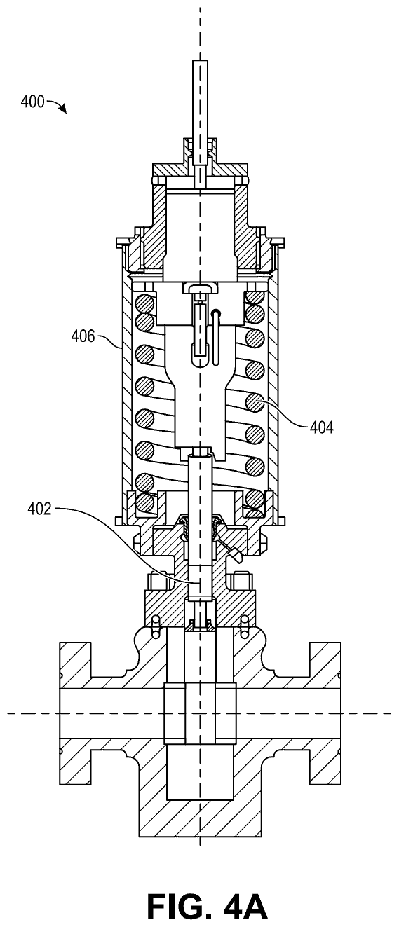

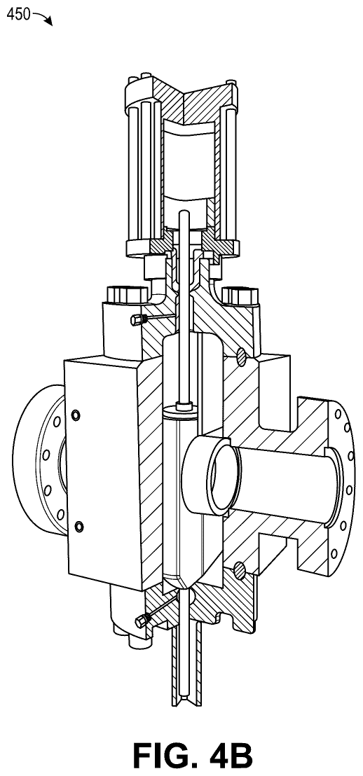

There are three typical valve configurations: Fail (Safe) Open (FO, FSO), Fail (Safe) Closed (FC, FSC) and Fail As Is (FAI). FIG. 4A illustrates an example of a Fail Closed valve 400 where changing the gate 402 changes the FO/FC configuration of the valve 400. FIG. 4B illustrates an example of a Fail As Is valve 450. When hydraulic fluid is lost to the FO valve, it will move automatically to the open position, driven by a spring in the actuator 406. Conversely for the FC valve 400, the spring 404 in the actuator 406 will move the valve to the closed position when hydraulic fluid is lost. The FAI valve 450 does not have a spring, therefore will not move when hydraulic fluid is lost and remain in the same position. The actuation signature will be different for each configuration.

Gate valves may be used in many areas of oil and gas operations, as well as other industries. Subsea valves are typically installed on the seabed and may be controlled remotely from the surface. The main difference between subsea valves and surface valves is normally limited to external packaging and mounting. The internal mechanisms are generally the same as the equivalent surface models, so the processes described here may apply equally in subsea valves or in surface valves or other in applications where a valve is operated remotely. Valve designs may vary between manufacturers, but each may have the same function. In oilfield applications, valves and actuators typically comply with standard API 6A and/or ISO 10423. In short, while this disclosure may discuss subsea valves specifically, the approach disclosed herein may also be applicable to valves in other locations such as valves installed in a wellbore (subsurface) as part of a completion string or a Drill Stem Test string.

As an addition to real-time surveillance tools on subsea equipment, operational insights which identify changes and events that could be of operational concern, enable subject matter experts to focus on maintenance planning as it provides users with certainty in, for example, subsea asset performance. This may further translate into more predictable operating costs across the life of the field, mitigating unplanned failures and the associated high cost of reactive maintenance and intervention. Furthermore, with the enablement of predictive maintenance, overall emissions may be reduced through consolidated trips to the field, planned spares and personnel, and automated real-time remote solutions which reduces human intervention.

A solution that provides operational insights to justify maintenance of subsea valves would be beneficial. Insights on a valve's condition, which may be analyzed during the valve's actuation, for example from open to close, may help predict potential failures and allows for timely maintenance, thus avoiding costly downtime.

Primary failure modes are the valve not moving (stuck in one position), not moving sufficiently (partial movement), fluid leak through a closed valve (internal leak) or a fluid leak to the environment (external leak). These may be caused by blockages, sand erosion, corrosion, part defects, or wear and tear of the valve or its ancillary components. Valve condition monitoring historically used be a mix of workflows, for example valve status, movement counts, flow coefficients (Cv) or efficiency tracking, leak detection from hydraulic fluid consumption, etc. Evaluation of the hydraulic valve actuation signature provides a new method to gain insight into the valve's health. By monitoring hydraulic actuator supply line pressure, return line pressure, and function line pressure, anomalies may be identified as a deviation to the normal time-series behavior. When available, hydraulic oil consumption and differential pressure across the bore may improve the detection of anomalies.

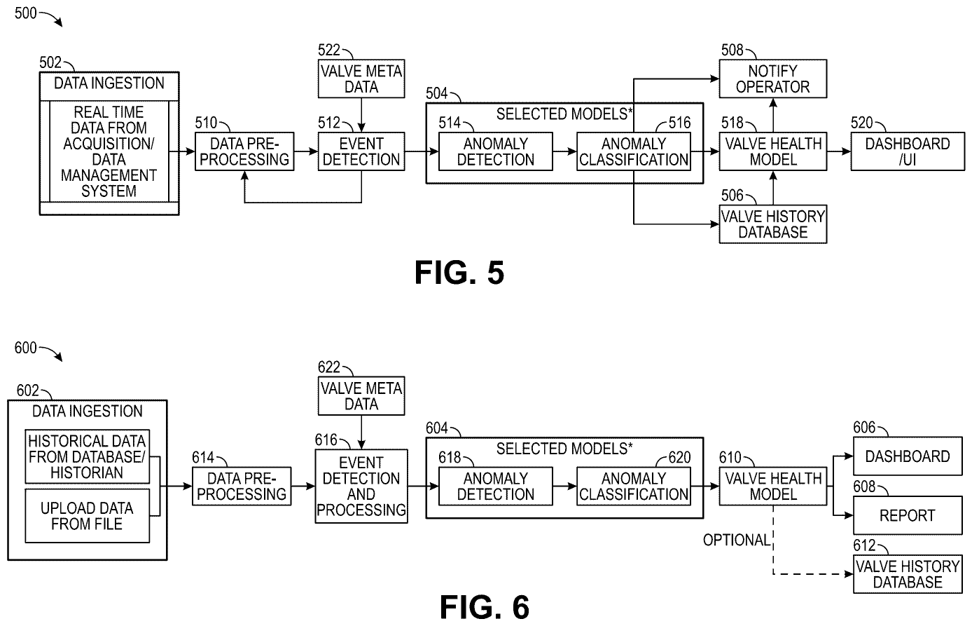

Some examples of using valve data include real time analysis, historical data analysis, and one-off analysis. In certain embodiments, real time analysis may be applied to a workflow 500 as illustrated in FIG. 5. Specifically, real time data 502 received from a wellsite or a data management system and then undergo data pre-processing 510 and event detection 512. The data may then be applied to one or more selected models 504 to continuously analyze the valve data as it is acquired. The selected models 504 may include anomaly detection 514 and anomaly classification 516. One goal of the real-time analysis may be to identify events, anomalies, or causes of events or anomalies, and then to determine the impact of that event on the health of the valve as it occurs. This approach may use the additional knowledge of the valves history stored in a valve history database 506. If not available, a historical data analysis may be conducted first. Real time analysis may be used to notify the operator 508 when an anomaly is detected in real time. In certain embodiments, the product of the real time analysis may be applied a valve health model 518, the results of which may be displayed to a dashboard or UI 520. Responsive action may then be taken if required based on the consequence and failure mechanism/cause, or if the detected event is determined to have an impact on valve health.

According to certain embodiments, historical data analysis may be applied to a workflow 600 as illustrated in FIG. 6. Specifically, data ingestion 602 which may include, for example, valve data captured during the operational life of the valve or valve data uploaded from a file or outside source, may undergo data pre-processing 614 and event detection 616. The data may then be applied to one or more models 604 that have been selected for modeling certain desired valve characteristics or event types. The selected models 604 may include anomaly detection 618 and anomaly classification 620. In certain embodiments, the models 604 may identify historical events (whether all or a subset of them), detect anomalies, and classify them accordingly. Historical analysis may help the operator understand the current status of the valve, its current health and, based on the types of anomalies it has experienced throughout its life, and what action should be taken to repair or extend its life using a valve health model 610. The analysis performed by the valve health model 612 may be provided to the operator via a dashboard 606 displayed on a display, or as written report 608. The valve data used by the valve health model 610 may then be stored in a valve history database 612 for future use.

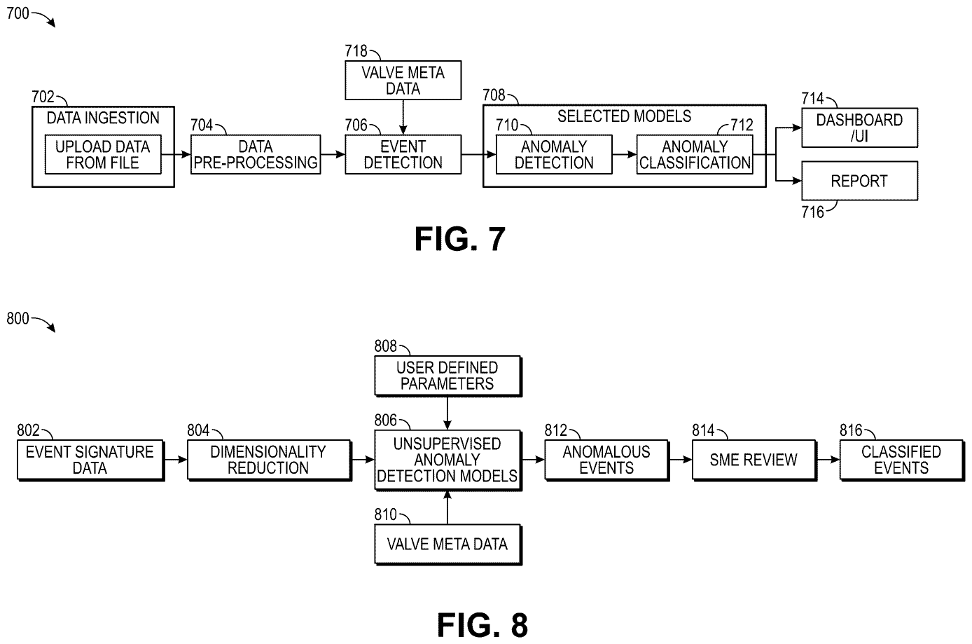

In certain embodiments, a one-off analysis workflow 700 as illustrated in FIG. 7 may follow a similar process to the historical analysis workflow 600, where the data injection 702 may only include a snapshot of historic data may be analyzed. This approach may be used, for example, when full historical data is unavailable, when troubleshooting is an issue, or during root cause analysis. Events, anomalies and causes may be identified using this approach, however the ability to determine the valve's health status may be difficult without additional historical data. The snapshot data may undergo data pre-processing 704 and event detection 706. The data may then be applied to one or more models 708 that have been selected for modeling certain desired valve characteristics or event types. The selected models 708 may include anomaly detection 710 and anomaly classification 712. The analysis performed by the selected models 708 may be provided to the operator via a dashboard 714 displayed on a display, or as written report 716.

According to certain embodiments, data collection or injection may be loaded directly from a source, such as a database as in 502, historical or other application storage as in 602, via an API or other connection into temporary local storage. When direct connection to a data source is not possible, data may be loaded via a data file(s) e.g., CSV file.

In certain embodiments, data pre-processing 510, 614, 704 may include uploading multiple files or data from multiple sources. The data may be joined/concatenated into one table in the local storage. The data may be cleaned and prepared by, for example, performing unit conversions, dropping any duplicates, interpolating missing values, and calculating variables for further processing.

In certain embodiments, event detection 512, 616, 706 may include detecting the potential start of the events, for example open, close, or bad events, by scanning the absolute value of function pressure with a user-defined pressure rate threshold. The approach may then create a potential window for further researching the start and end of an event. Utilizing this workflow, however, may capture some event windows that are either bad sensor data readings, or data that is actually a part of a larger event. Some safeguard logics based on the domain expert opinion may be written to flag and prevent these kinds of windows from being processed further. The valve characteristics (e.g. type, size) may be entered by the user in each workflow 500, 600, 700 as valve meta data 522, 622, 718 and stored for repeated use. If the characteristics are unknown, they may in some embodiments be determined by the process described below. After it passes the non-event filters, the event window may then be classified as a “hydraulically supported” or a “non-hydraulically supported” event before it will be labelled as “open actuation” or “close actuation” at the end of the function. This may be used to derive statistics from the event window to help the unsupervised algorithm detect anomalies in the anomaly detection step.

For example, in one embodiment, a “hydraulically supported” event may be an open event for a FC valve, a close event for a FO Valve, and open or close event for a FAI valve. This is when high pressure hydraulic fluid is directed into the actuator, moving the actuator piston, stem and gate down. In the case of FO and FC valves, the actuator spring is compressed in the process, requiring additional force (pressure). In a FAI valve, there is frequently no spring so there is less force/pressure required to close/open the valve.

Conversely, a “non-hydraulically supported” event may be an open event for a FO valve or a close event for a FC Valve. Because the actuator spring provides the force required to move the gate, the hydraulic fluid is allowed to vent to the return line to prevent a hydrostatic lock on the piston. Therefore, based on how the hydraulic pressure responds to the different processes occurring for each configuration during open and close, the signature for event may be used to classify the valve type.

In one embodiment of the statistical derivation step, the event window is divided into three phases; the first phase when the function pressure starts to rise/drop until friction is overcome and the valve starts to move (crack pressure), the second phase being when the valve is moving from open to closed or vice versa, where the pressure increases/decreases with a certain gradient, and the last phase when the valve has completed movement seen when the function pressure is in equilibrium with the supply/return pressure. Statistical techniques, such as exponential decay curve fit and Fourier transform feature extraction may be used. In one implementation, at least 25 features (including duration, crack pressure, and end pressure) may be generated. For example, as the window may be divided into three distinct phases, for each phase, duration, pressure gradient, and standard deviation may be calculated. These metrics provide insight into how the pressure changes and stabilizes over time. The energy consumed during the valve operation may be computed by integrating the pressure over time using the trapezoidal rule in equation 1:

$$Energy = {\int }_{{t}_{start}}^{{t}_{end}} {P}_{fun} ( t ) dt \qquad ( 1 )$$

where t is time and P_{fun} is functional pressure. This will provide quantitative assessment of the work performed by valve during movement, which could indicate the efficiency and performance of the asset. Using Pearson correlation coefficients between the three pressures, anomalies may be detected later when there are deviations from the standard correlation values in the data set:

$$Correlation ( X , Y ) = \frac{cov ( X , Y )}{{σ}_{X} {σ}_{Y}} \qquad ( 2 )$$

where Cov(X,Y) is the covariance between pressures X and Y, and σX, σY are the standard deviations of the respective pressure. As the supply pressure decreases during a hydraulically supported event, an RC (resistor-capacitor) filter model can be fitted to supply pressure data overtime. The RC filter is a common model used to describe the exponential decay of voltage in circuits, which is expressed as follows:

$$P ( t ) = {V}_{0} \cdot {e}^{t / τ} \qquad ( 3 )$$

where P(t) is the pressure at time t, V₀ is the initial pressure, and T is the time constant that characterizes the rate of decay. The fitting process may be performed using a non-linear least-squares optimization method. An anomalous profile on supply pressure will trigger the anomaly detection method with the help of this variable. Because friction most of the time may be characterized by an unstable function pressure growth, Fourier transform (FT) may be applied to function pressure to analyze its frequency characteristics. FT converts the time-domain signal into its frequency-domain representation to allow for identifying dominant frequency components:

$$FT [ P ( t ) ] = {\sum }_{n = 0}^{N - 1} P ( {t}_{n} ) \cdot {e}^{- j 2 π \frac{kn}{N}} \qquad ( 4 )$$

$$Power ( f ) = {\vert FT ( f ) \vert}^{2} \qquad ( 5 )$$

where Power(f) is derived from Fourier coefficients, representing the distribution of power across different frequency components. When available, additional sensor data may be added to the model to improve the identification of valve events. This may include hydraulic fluid flow rates, valve position sensors/limit switches and process fluid pressure, temperature and flow rate.

According to certain embodiments, training of the selected models for anomaly detection 514, 618, 710 and anomaly classification 516, 620, 712 may include an anomaly detection and classification workflow seen in FIGS. 8-11 that may be applied depending on the amount of available data for normal and anomalous events. The choice of models and workflow may be determined from the analysis of the installation and the amount of available data during an initial assessment.

In the example of subsea valves, they are normally operated at a low frequency, only a few times per year in some cases. Due to their typically high reliability, most events are normal and very few anomalies occur. This may create several issues for training classification machine learning models: a class imbalance where one class (normal events) dominate the model, there may be very few repeated anomalies, and the possibility that anomalies that are unknown to the model will occur in the future. An unsupervised anomaly detection model and workflow 800 as seen in FIG. 8 may be used for this scenario to detect new anomalies without having previously seen them or many instances of them. These unknown anomalies may then be classified by a subject matter expert (SME).

According to certain embodiments, the workflow 800 may be implemented to detect anomalous events where limited data may be available and the number or types of anomalies are relatively unknown. Unsupervised approaches such as Gaussian mixture model (GMM) may be used to cluster anomalies and the workflow 800 may take advantage of dimensionality reduction methods to cluster the data without labels. For example, dimensionality reduction may be performed as at 804, using a technique such as principal component analysis (PCA), may first be applied to the valve event signature data received as at 802. Certain select dimensions may be passed to an unsupervised anomaly detection machine learning model (e.g. Isolation Forest, HDBSCAN) as at 806 with both projected and non-projected versions of scaled event summary data. An alternative approach may include projecting the data into t-SNE hyperspace, then dynamically select the current operating region, training a regression model to project future data and classifying it as an anomaly if it falls beyond the current operating cluster. The selection of the approach may be dependent on the characteristics of the input data and selected based on the technique that yields the highest detection of anomalies.

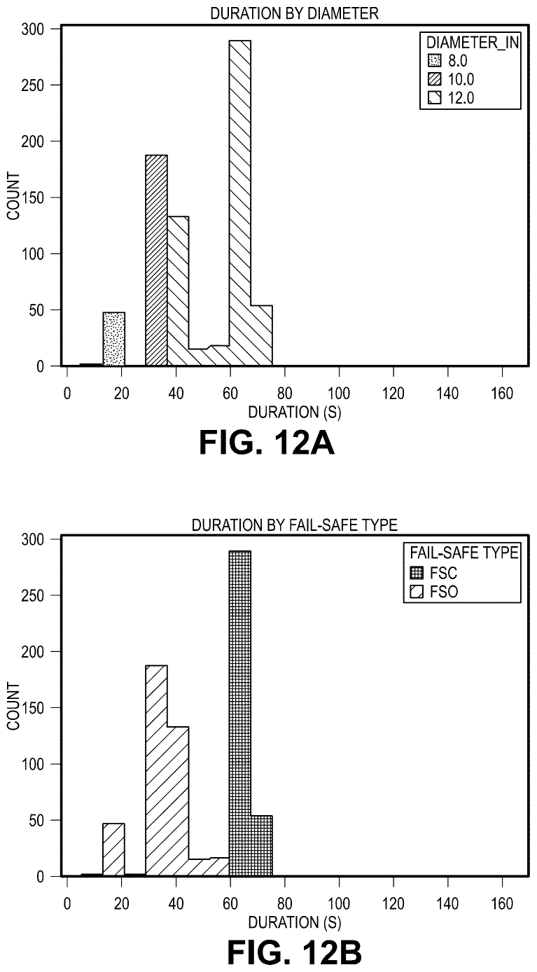

In certain embodiments, user defined parameters as at 808 and valve meta data as at 810 may be applied to the unsupervised anomaly detection model as at 806. For example, there may be distinguishable distributions of values between different valve types, specifically in relation to fail-safe type and diameter. FIGS. 12A and 12B show the univariate distribution of duration, one of the main parameters in hydraulically supported valve events. As depicted in FIG. 12A, the larger the valve's bore, the more time is typically needed to move it. However, bimodality was observed in the 12-inch group, which was found to stem from different fail-safe types. As illustrated in FIG. 12B, the right peak corresponds to the “fail-safe close” type, meaning the hydraulic actuation opens the valve, while the left peak is from the “fail-safe open” type, where the hydraulic actuation closes the valve. This analysis may point to a decision to implement model granularity, ensuring that different actuation methods, valve diameters, and valve fail-safe types such that each have their own models.

In certain embodiments, events that are detected to be potentially anomalous events may be consolidated or collected as at 812. A SME may review each of the potential anomalous events as at 814, and then designate if the event is in fact an anomalous event, and classify what type of anomalous event it may be as at 816.

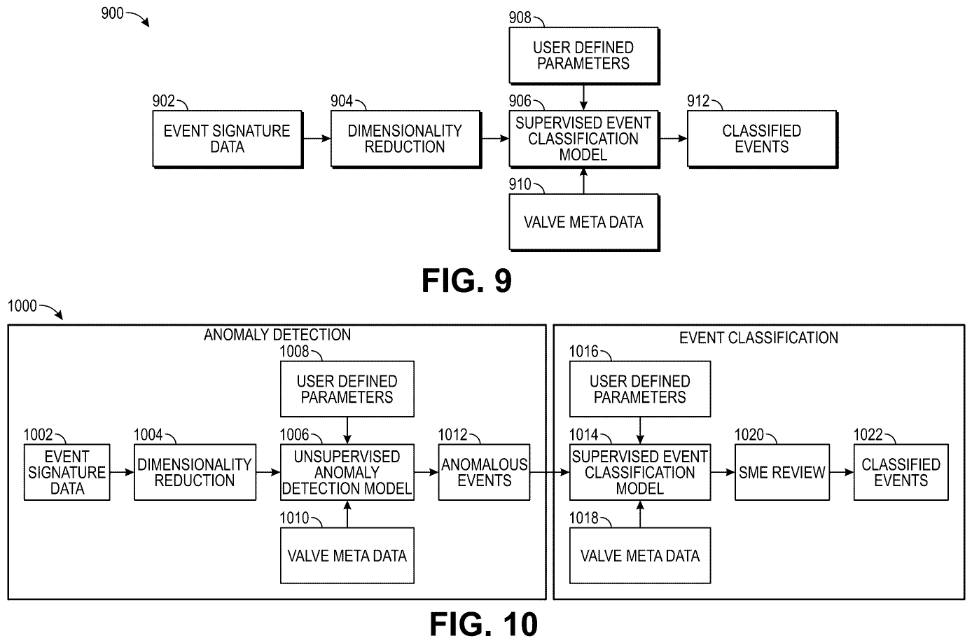

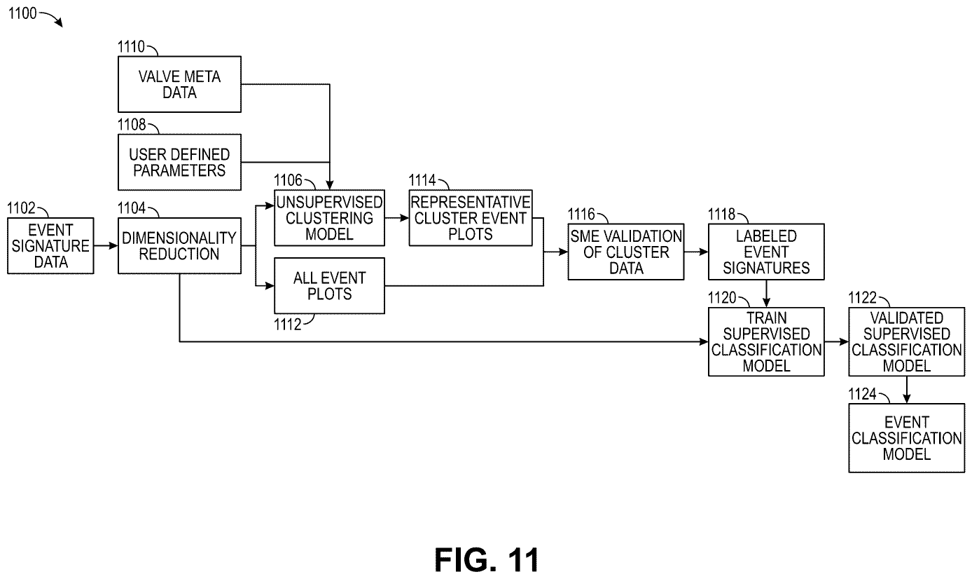

According to certain embodiments, in installations with a large number of valve events, well known anomalies, and failures, the anomalous signatures may be classified according to the supervised event classification model and workflow 900 seen in FIG. 9. For example, dimensionality reduction may be performed as at 904, using a technique such as principal component analysis (PCA), may first be applied to the valve event signature data received as at 902. Certain select dimensions may be passed to a supervised anomaly detection machine learning model as at 906. The supervised event classification model may be used to identify similar but not necessarily connected events, based on the characteristics of the event signature received as at 902. The supervised event classification model may be trained by the process detailed in FIG. 11 described further below. In certain embodiments, user defined parameters as at 908 and valve meta data as at 910 may be applied to the supervised anomaly detection model as at 906. In certain embodiments, events may then be classified as an anomalous event as at 912.

In certain embodiments, the supervised event classification model 906 may be trained following a training workflow 1100 illustrated in FIG. 11. For example, after receiving event signature data as at 1102, dimensionality reduction may be performed as at 1104, using a technique such as principal component analysis (PCA). Certain select dimensions may be passed to an unsupervised anomaly detection machine learning model as at 1106. In certain embodiments, user defined parameters as at 1108 and valve meta data as at 1110 may be applied to the unsupervised anomaly detection model as at 1106. A SME may review or validate the event signature data as at 1116. The SME(s) may then label event signatures that may be appropriate to train, test, and validate a supervised classification model as at 1118. In the case of a small number of event signatures, the SME may review and label all event plots directly received after undergoing dimensionality reduction as at 1112. In the case of a large number of event plots, the unsupervised clustering model may be used to group events with similar signatures and provide representative cluster event plots as at 1114. In certain embodiments, the representative cluster event plots may include data from multiple valves of the same/similar size, type and use may be combined to create a larger data set for the purpose of anomaly detection and classification. Valve health models and analysis may also use data from individual valves. A representative sample of plots from each cluster may be reviewed by the SME(s) and the plots in the cluster may be assigned the same label. This method has the advantage of not requiring full time and/or real time SME support to label anomalous events. The labeled event signatures and certain select dimensions may then be provided to the supervised classification model in order to train it as at 1120, which may be further validated by the SME as at 1122. Once validated, the event classification model may be ready for further use as at 1124, for example within the supervised event classification model and workflow 900 described above.

According to certain embodiments, event classification may be performed using a hybrid workflow 1000 illustrated in FIG. 10. The hybrid workflow 1000 may provide an intermediate solution that may be suitable when there is a moderate number of normal and anomalous events, the anomalous events being a composite of known or likely events and unknown or unlikely events. In such a scenario, there may be too many anomalies to be reviewed individually, but not enough to be fully characterized. The hybrid workflow 1000 may first use an unsupervised anomaly detection model to identify the anomalous events. For example, after receiving event signature data as at 1002, dimensionality reduction may be performed as at 1004, using a technique such as principal component analysis (PCA). Certain select dimensions may be passed to an unsupervised anomaly detection machine learning model (e.g. Isolation Forest, HIDBSCAN) as at 1006 with both projected and non-projected versions of scaled event summary data. In certain embodiments, user defined parameters as at 1008 and valve meta data as at 1010 may be applied to the unsupervised anomaly detection model as at 1006. Events that are detected to be potentially anomalous events may be consolidated or collected as at 1012. The anomalous events may then be classified by a supervised event classification model. For example, the anomalous events may be fed to the supervised event classification model as at 1014. In certain embodiments, additional or further user defined parameters as at 1016 and valve meta data as at 1018 may be applied to the supervised anomaly detection model as at 1014. In certain embodiments, events may undergo SME review as at 1020 and then be classified as an anomalous event as at 1022.

In certain embodiments, anomalies that are classified with low confidence may be flagged for additional review by an SME and labelled appropriately. The classified event data may be fed back to the supervised model for retraining to improve future performance.

According to certain embodiments, the workflow 600 may translate historical and detected valve cycles and anomalous events into its degradation towards the valve health. In historical analysis mode, the life of the valve, based on the available data, may be processed and valve events fed in the valve health model as at 610. In real time or in a stand alone mode, the previous use history of one or more valves may be recovered from the received valve history database as at 602. Previous use data may include number of valve cycles (open/closed), prior anomalous events, critical operational data or events where sensors or data is available, and maintenance or repair events. Valves have a cycle limit. Even under perfect conditions, wear and tear on seals and metallic surfaces will eventually result in a failure after a certain number of cycles. As noted below, a quantified life, for example life as function of the number of allowed cycles, is rarely known with any accuracy due to the valve qualification and how it is used. Generally, each valve cycle will reduce the valve's remaining life by a certain amount. Different anomalous event will reduce the life by different amounts, depending on the type and severity of the failure mode/cause. Additionally, exposure to certain hydrocarbon fluids, gases and chemicals, and extreme (high and low) pressure and temperature conditions while the valve is static, or environmental conditions (e.g. salt water) may reduce the remaining life. Well operations such as wireline/slickline or coil tubing intervention, where tooling is introduced into the well through a Christmas tree valve, may result in additional damage to a valve that reduces its remaining life. Failure, as used herein, includes a failure of a specified function of the valve, not only hard failures such as the rupture of the valve body or seal blow out/stuck. Different operators/manufacturers may have their own definition of what is a failure and the model weights/criteria may be adjusted accordingly.

For example, API 6A valves may be validated (qualified) to a certain number of cycles, depending on criticality and intended use conditions. The test conditions and number of cycles have generally been determined by the industry as a minimum standard required to demonstrate equivalent reliability between manufacturers. In some cases, some customers require extended testing two to three times the minimum API 6A requirement. However, the standard and extended tests are generally not intended to be a determination of total life. In many cases, valve usage in the field far exceeds the number of cycles from qualification. API 6A testing is generally conducted at minimum and maximum extremes of pressure and temperature and the actual use conditions are well below these extremes. When failures do occur, in some cases before reaching the number of cycles in the API 6A tests, the failures are often due to the presence of, for example, hydrocarbons, H2S/CO2 or sand/solids that have degrading effect on the valve life. These are not generally accounted of in the API 6A tests which are typically conducted with fresh water or nitrogen. Additionally, manufacturers rarely intentionally test to end of life (failure) and stop once the minimum number of cycles is met. Normally customers will rely on return of experience from previous similar installation and material testing.

Therefore, it may be beneficial to use different approaches to determining valve health and predict the remaining life or when maintenance is required, depending on the available data and history of failures.

When historical failures have occurred and sufficient data is available, a machine learning model, for example a deep learning Convolutional Neural Network model (CNN), may be used. This approach has the advantage of the engineer not requiring deep knowledge of the relationships between input data. This is captured by the model during the training process. When physics of failure or degradation are qualifiable with a numerical or similar model (referred to as a “physics model”), they may be used to predict the valve health. The models may use the available data to predict the remaining useful life. They may be combined in a workflow with machine learning models. In this implementation, the physics model may be used to simulate normal and anomalous events leading to failure. This may be used as input to a machine learning model, such as a CNN, to predict the remaining life of the valve.

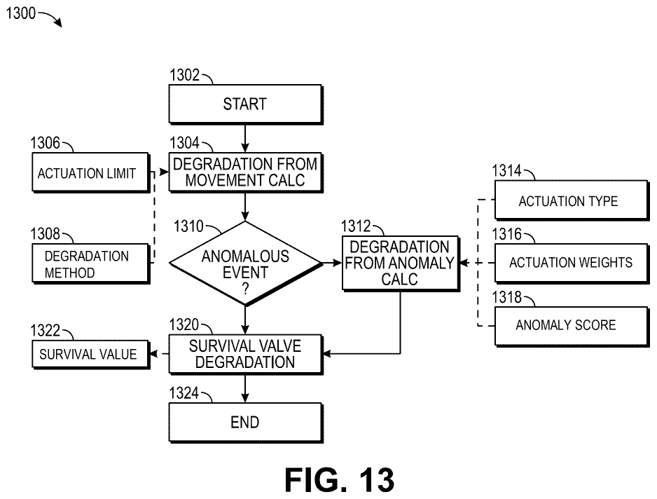

When insufficient data is available and/or no failures have occurred, another approach may be to manually select and tune a statistical model to fit the available data and expected degradation of remaining life. In certain embodiments, performance of the valve health model as at 518, 610 may include performing a valve life optimization workflow 1300 as seen in FIG. 13. The valve life optimization workflow 1300 may be used that provides that a model may be tuned to a particular operating environment and use profile of each valve, based on return of experience with the equipment. The different degradation methods may be programmed in this workflow to let the users select the most suitable degradation model and parameters for their valve system. For example, after starting from a start point as at 1302, valve degradation from movement may be calculated as at 1304. The calculation of the degradation due to movement may include inputting an actuation limit 1306 and a known degradation method 1308. Next, a determination as to whether an anomalous event has occurred may be performed as at 1310. If so, valve degradation from an anomaly may be calculated as at 1312. In certain embodiments, calculating valve degradation from an anomaly may include inputting an actuation type 1314, one or more actuation weights 1316, and/or an anomaly score 1318. A final survival valve degradation, based on the calculated degradation from movement and the calculated degradation from anomalies, may be determined as at 1320. A survival value may then output to a user via a display or other notification means as at 1322. The workflow 1300 may then end as at 1324.

According to certain embodiments, the actuation weights that may be input as at 1316 may include a linear degradation seen in equation 6 that may yield constant degradation value for each valve event (N) or an exponential degradation seen in equation 7 that may apply a more aggressive approach where valve health diminishes rapidly in the initial stages of its lifecycle, particularly after significant or frequent events.

$$Δ {D}_{linear} = \frac{1}{{N}_{max}} \qquad ( 6 )$$

$$Δ {D}_{exponential} ( n ) = ( 1 - e \text{?} ( \frac{n + 1}{{N}_{max}} ) ) - ( 1 - e \text{?} ( \frac{n}{{N}_{max}} ) ) \qquad ( 7 )$$

$$\text{?} \text{indicates text missing or illegible when filed}$$

Using an exponential degradation may be particularly useful for valves known to wear out faster after a certain usage threshold. The actuation weight may also include a logarithmic degradation seen in equation 8 that may capture a slower, decelerating decline in valve health, where the impact of each successive event becomes less significant overtime. This may be suitable for systems where initial usage causes significant wear, but the degradation rate decreases as the valve continues to operate, reflecting a stabilization in performance after an initial adjustment period.

$$Δ {D}_{logarithmic} ( n ) = \frac{log ( 1 + ( n + 1 ) )}{log ( 1 + {N}_{max} )} - \frac{log ( 1 + n )}{log ( 1 + {N}_{max} )} \qquad ( 8 )$$

The actuation weight may also include a power-law degradation seen in equation 9 that may describe a scenario where valve health decreases in a manner that is initially steep but gradually flattens out, indicating that earlier events have a more pronounced effect than later ones. A power-law weight may be well-suited for valves that experience a sharp decline in health early on, but become more resilient as they approach their operational limits.

$$Δ {D}_{power - law} ( n ) = {( \frac{( n + 1 )}{{N}_{max}} )}^{k} - {( \frac{n}{{N}_{max}} )}^{k} \qquad ( 9 )$$

In certain embodiments, the actuation weight may also include a weighted degradation where specific events known or demonstrated to cause more significant degradation may be assigned a higher degradation value or weighting than less significant events.

In applications when additional sensors or data is available, for example in the supervised event classification model and workflow 900 or the hybrid workflow 1000 described above, the valve life optimization model 1300 may include additional model inputs with different weights depending on their significance, such inputs including but not limited to flow rate data where a high flow rate may lead to erosion, pressure data where a high pressure, over pressure, and pressure cycling may lead to seal or housing failure, sand/solids detection data which may leading to erosion, damage to seals and sealing surfaces, and blockages, acid gases data where CO2 or H2S may lead to corrosion and seal damage, subsurface chemical injection data which may lead to seal degradation, and maintenance and repair data where a maintenance event should “reset” as valve life back to “as-new” depending on what service level performed.

In certain embodiments, the valve life optimization workflow 1300 may take the historical valve degradation data and prediction of remaining useful life, and, by adjusting parameters such as frequency of valve cycles, predict the maximum/optimized remaining useful life.

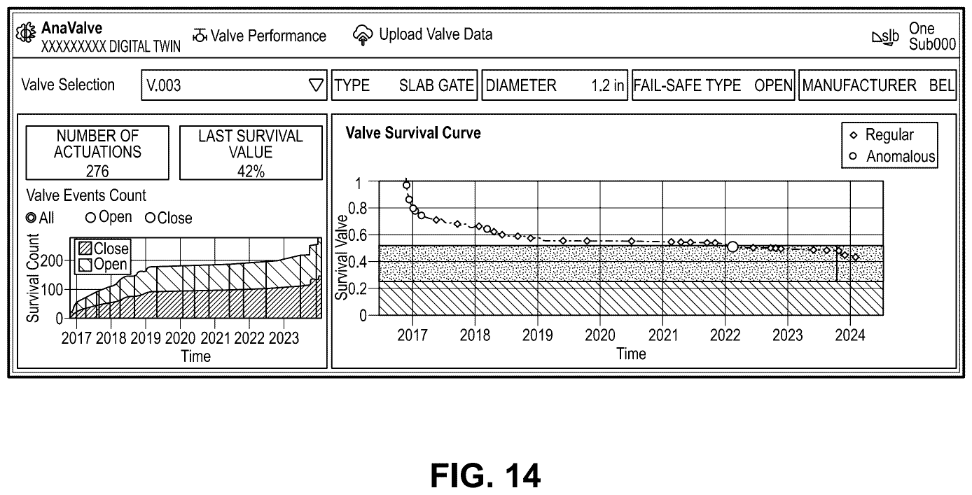

In certain embodiments, a dashboard/UI may be provided as at steps 520, 606, 714. An example dashboard 1400 may be seen in FIG. 14. The dashboard 1400 may be designed to provide the operator insights into the valve performance, for example the survival value output 1322. The UI may be designed to give high-level overviews of valve performance to detailed analysis of specific events. The UI may be customizable to the installation and user preferences. Moreover, the application may include a robust data upload interface that allows users to upload raw valve data directly into the system. The dashboard may be part of, for example, a stand-alone application or integrated into a data management platform. FIG. 14 shows a few details of the features available inside an embodiment of a web application, however this is for illustrative purposes only. Additional features or other UI elements not explicitly shown may also be included within the scope of the current disclosure.

When the analysis is complete, a report may be produced as at 608, 716 summarizing the findings from the analysis. The report may include analysis used or found in the dashboard 1400.

When the analysis is complete, data may be stored in the valve history database as at 506, 612. The data stored may include identifying information about the valve (e.g. serial number, model, size, ID, location), event dates, event signatures, anomalies and classifications, cumulative cycle count. The database may facilitate the valve health process to model the complete history of the valve. It may also allow operators to have access to value history without the need for recovering or storing large volumes of time series data and reprocessing it.

### Exemplary Method

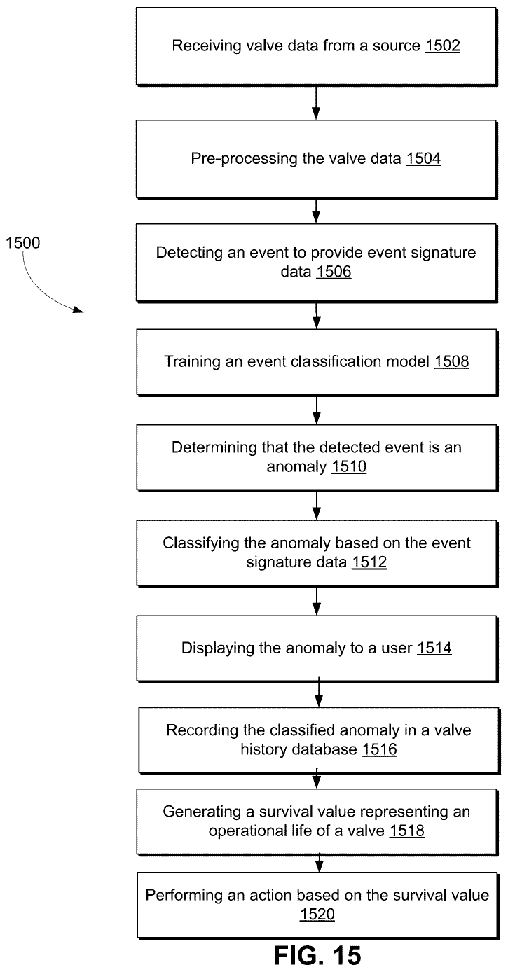

FIG. 15 illustrates a flowchart of a method 1500 for monitoring valve health and event detection. In certain embodiments, the method includes receiving valve data from a source as at 1502. Receiving the valve data from the source may include receiving valve data from real-time sensors disposed at a wellsite, receiving valve data from a historical database, or receiving valve data uploaded from a file. In an example the valve data may include or indicate whether a valve has been opened or closed, whether a valve has failed to be open or closed, and pressure values from the hydraulic system (supply line, function line/chamber, and return line) of the valve.

According to certain embodiments, the method 1500 may include pre-processing the received valve data as at 1504. Pre-processing the received data may include concatenating data received from multiple sources.

According to certain embodiments, the method 1500 may include detecting at least one event based on the pre-processed valve data to provide event signature data as at 1506. Detecting the at least one event may include detecting an opening or closing of a valve. In certain embodiments, detecting the at least one event may include grouping or chunking raw time series data of the valve's hydraulic pressure system into snapshots of valve opening and closing events. Based on these snapshots, the valve signature data then generated. In certain embodiments, detecting the at least one event may be based on valve meta data provided by a user. In certain embodiments, detecting the at least one event may include detecting a change in pressure from an initial pressure at a valve, detecting a pressure gradient at the valve, and detecting a return in pressure to the initial pressure at the valve. In certain embodiments, the event signature data may include the change in pressure at a valve over a predetermined period of time.

According to certain embodiments, the method 1500 may include training an event classification model according to the event signature data as at 1508. Training the event classification model according to the event signature data may include reviewing a plurality of plots of the event signature data by a subject matter expert, labeling the event signature data by the subject matter expert, providing the labeled event signature data to a classification model, and validating the classification model by the subject matter expert.

According to certain embodiments, the method 1500 may include determining that the detected event is an anomaly based on the event signature data and using the trained event classification model as at 1510. For example, the event may be detected as an anomaly if it has had a prolonged duration. And further inference on the event may detect it as a frictional movement event. As, other than the prolonged duration, the frequency component from the Fourier signature of the event may also give a high anomalous value.

According to certain embodiments, the method 1500 may include classifying the anomaly based on the event signature data, valve meta data, and user defined parameters, as at 1512. Classifying the anomaly may include reviewing the anomaly by a subject matter expert and labeling the anomaly with a classification. In an example, the anomaly may be classified, for example, as a frictional movement event, a pressure event, or a duration event. In an example, the anomaly may be classified by the subject matter expert or by the trained event classification model.

According to certain embodiments, the method 1500 may include displaying the anomaly to a user, as at 1514. Displaying the anomaly may include alerting an operator of the anomaly, displaying a visual representation of the anomaly is a dashboard displayed to the user, or generating a report for the user.

According to certain embodiments, the method 1500 may include recording the classified anomaly in a valve history database, as at 1516.

According to certain embodiments, the method 1500 may include generating a survival value representing an operational life of the valve based on the event signature data and the classified anomaly, as at 1518. In an example, each anomaly may contribute to the survival value by a corresponding anomaly score, weighted by a constant supplied by the user.

According to certain embodiments, the method 1500 may include performing an action based on the detected event being classified as an anomaly and/or the survival value, as at 1520. Performing the action may include generating or transmitting a signal that recommends, instructs, or causes an action to occur. The action may include a physical action. The physical action may include actuating one or more valves in a wellbore, repairing or replacing one or more valves in the wellbore, varying a rate or concentration of a fluid being pumped into the wellbore, or a combination thereof. For example, in response to the survival value falling beneath a warning threshold, the actuation frequency, actuation speed, and limiting differential pressure may be reduced. If the survival value falls beneath a danger threshold, the associated well or flowline may be restricted or shut-in to avoid the risk of leakage, the valve may be locked in the safest achievable position, a series of diagnostics tests may be performed, or physical intervention may be planned including hydraulic line flushing, valve module replacement, actuator replacement, seal replacement (if design allows), or complete tree and/or manifold intervention.

### Exemplary Computing System

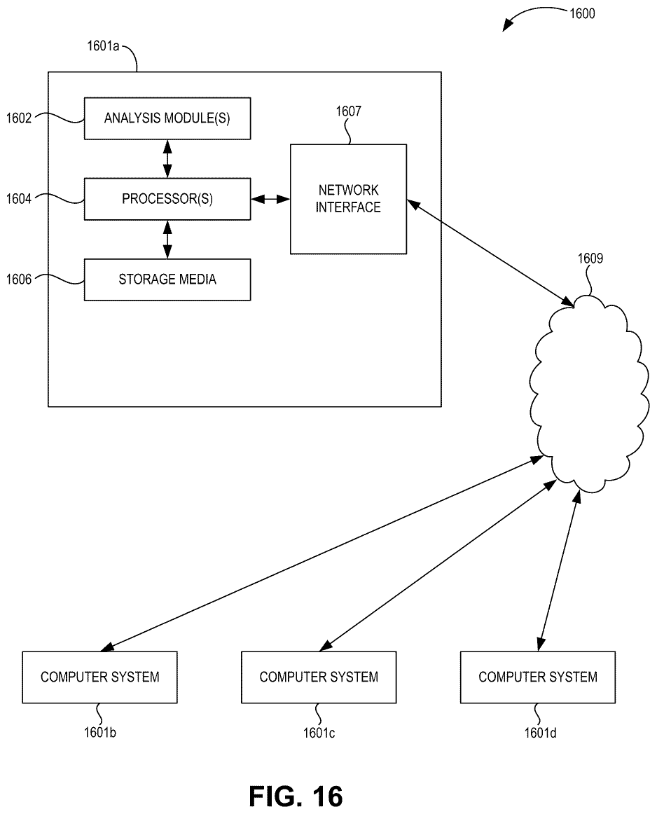

In some embodiments, the methods of the present disclosure may be executed by a computing system. FIG. 16 illustrates an example of such a computing system 1600, in accordance with some embodiments. The computing system 1600 may include a computer or computer system 1601A, which may be an individual computer system 1601A or an arrangement of distributed computer systems. The computer system 1601A includes one or more analysis modules 1602 that are configured to perform various tasks according to some embodiments, such as one or more methods disclosed herein. To perform these various tasks, the analysis module 1602 executes independently, or in coordination with, one or more processors 1604, which is (or are) connected to one or more storage media 1606. The processor(s) 1604 is (or are) also connected to a network interface 1607 to allow the computer system 1601A to communicate over a data network 1609 with one or more additional computer systems and/or computing systems, such as 1601B, 1601C, and/or 1601D (note that computer systems 1601B, 1601C and/or 1601D may or may not share the same architecture as computer system 1601A, and may be located in different physical locations, e.g., computer systems 1601A and 1601B may be located in a processing facility, while in communication with one or more computer systems such as 1601C and/or 1601D that are located in one or more data centers, and/or located in varying countries on different continents).

A processor may include a microprocessor, microcontroller, processor module or subsystem, programmable integrated circuit, programmable gate array, or another control or computing device.

The storage media 1606 may be implemented as one or more computer-readable or machine-readable storage media. Note that while in the example embodiment of FIG. 16 storage media 1606 is depicted as within computer system 1601A, in some embodiments, storage media 1606 may be distributed within and/or across multiple internal and/or external enclosures of computing system 1601A and/or additional computing systems. Storage media 1606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

It should be appreciated that computing system 1600 is merely one example of a computing system, and that computing system 1600 may have more or fewer components than shown, may combine additional components not depicted in the example embodiment of FIG. 16, and/or computing system 1600 may have a different configuration or arrangement of the components depicted in FIG. 16. The various components shown in FIG. 16 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1600, FIG. 16), and/or through manual control by a user who may make determinations regarding whether a given step, action, template, model, or set of curves has become sufficiently accurate for the evaluation of the risk index.

While any discussion of or citation to related art in this disclosure may or may not include some prior art references, applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to utilize the invention and various embodiments with various modifications as are suited to the particular use contemplated.

What is claimed is:

1. A method for monitoring valve health, the method comprising:
receiving valve data from a source;
pre-processing the received valve data;
detecting at least one event based on the pre-processed valve data to provide event signature data;
determining that the detected event is an anomaly based on the event signature data; and
classifying the anomaly based on the event signature data.

2. The method of claim 1, wherein receiving valve data from the source comprises receiving the valve data from real-time sensors disposed in a wellbore, receiving the valve data from a historical database, or receiving the valve data uploaded from a file.

3. The method of claim 1, wherein pre-processing the received valve data comprises concatenating the valve data received from a plurality of sources.

4. The method of claim 1, wherein detecting the event comprises detecting an opening or closing of a valve.

5. The method of claim 1, wherein detecting the event is based on valve meta data provided by a user.

6. The method of claim 1, wherein detecting the event comprises:
detecting a change in pressure relative to an initial pressure at a valve;
measuring a pressure gradient at the valve; and
determining a pressure equilibrium at the valve.

7. The method of claim 1, further comprising training an event classification model to classify the anomaly according to the event signature data.

8. The method of claim 7, wherein training the event classification model to classify the anomaly comprises:
reviewing a plurality of plots of the event signature data by a subject matter expert;
labeling the event signature data by the subject matter expert;
providing the labeled event signature data to the event classification model; and
validating the classification model by the subject matter expert.

9. The method of claim 1, wherein classifying the anomaly is further based on valve meta data or user defined parameters input by a user.

10. The method of claim 1, further comprising performing an action based on the classified anomaly.

11. A computing system, comprising:
one or more processors; and
a memory system comprising one or more non-transitory computer-readable media storing instructions that, when executed by at least one of the one or more processors, cause the computing system to perform operations, the operations comprising:
receiving valve data from a source;
pre-processing the received valve data;
detecting at least one event based on the pre-processed valve data to provide event signature data;
determining that the detected event is an anomaly based on the event signature data; and
classifying the anomaly based on the event signature data.

12. The computing system of claim 11, wherein the operations further comprise displaying the anomaly to a user on a display.

13. The computing system of claim 12, wherein displaying the anomaly to the user comprises:
sending an alert to the user;
displaying a visual representation of the anomaly on a dashboard displayed to the user; or
generating a report for the user.

14. The computing system of claim 11, wherein the operations further comprise recording the classified anomaly in a valve history database.

15. The computing system of claim 11, wherein the operations further comprise generating a survival value representing an operational life of a valve based on the event signature data and the classified anomaly.

16. The computing system of claim 15, wherein the survival value comprises a survival valve degradation value based on a determined degradation from movement of the valve and a determined degradation from anomalies at the valve.

17. The computing system of claim 15, wherein the operations further comprise displaying the survival value to a user on a display.

18. The computing system of claim 11, wherein detecting the event based on the pre-processed valve data to provide event signature data comprises detecting the event by an unsupervised detection model, and
wherein determining that the detected event is an anomaly based on the event signature data comprises determining that the event is an anomaly by a supervised classification model.

19. The computing system of claim 11, wherein the operations further comprise performing an action based on the classified anomaly wherein performing the action comprises generating or transmitting a signal that instructs or causes an action to occur, wherein the action comprises a physical action, and wherein the physical action comprises actuating one or more valves in a wellbore, repairing or replacing one or more valves in the wellbore, varying a rate or concentration of a fluid being pumped into the wellbore, or a combination thereof.

20. A non-transitory computer-readable medium storing instructions that, when executed by one or more processors of a computing system, cause the computing system to perform operations, the operations comprising:
receiving valve data from a source;
pre-processing the received valve data;
detecting at least one event based on the pre-processed valve data to provide event signature data;
determining that the detected event is an anomaly based on the event signature data; and
classifying the anomaly based on the event signature data.
